(19) United States
(12) Patent Application Publication
(10) Pub. No.: US 2022/0125046 A1
(43) Pub. Date: Apr. 28, 2022

(54) FLOWABLE CONCENTRATE COMPOSITION FOR AGRICULTRUAL SEEDS

(71) Applicant: Dow Global Technologies LLC, Midland, MI (US)

(72) Inventors: Jing Ji, Shanghai (CN); Wei Lu, Shanghai (CN); Ling Zhong, Shanghai (CN); Cheng Shen, Shanghai (CN); Peng Gao, Shanghai (CN)

(73) Assignee: Dow Global Technologies LLC, Midland, MI (US)

(21) Appl. No.: 17/434,504

(22) PCT Filed: Feb. 28, 2019
(86) PCT No.: PCT/CN2019/076512

§ 371 Date: Aug. 27, 2021

(51) Int. Cl. A01N 25/10; A01N 25/30; A01C 1/06

(52) U.S. Cl. CPC A01N 25/10; A01C 1/06; A01N 25/30

(57) ABSTRACT

The present disclosure provides for a flowable concentrate (FS) composition for forming a coating on an agricultural seed that includes an acrylic polymer having a glass transition temperature (Tg) of 0 to 35° C. measured according to ASTM D6604-00 (2017). In addition to the acrylic polymer, the FS composition further includes an agriculturally active compound, a water-soluble surfactant and water. The present disclosure also provides for a method of forming a coating on an agricultural seed using the FS composition and an agricultural seed coated with the FS composition of the present disclosure.

### FIELD OF DISCLOSURE

The present disclosure relates generally to coatings for agricultural seeds and more particularly to a flowable concentrate composition for agricultural seeds.

### BACKGROUND

In recent years, seed coating formulations have been used to help improve or enhance crop performance. Generally, such seed coating formulations utilize a flowable concentrate for seed treatment. Flowable concentrate (FS) compositions are suspensions of solid active ingredients in water that are applied to seeds to form a coating on the seeds prior to planting. FS compositions typically include additives (e.g., a film forming agent) that help bind the coating to the seed surface along with colorants that indicate the seed has been treated. FS compositions also include active ingredients that is evenly distributed over the seed surface. Other components of the FS compositions typically include a wetting agent, a dispersant and a thickener.

Given all the research into and the known options for FS compositions, seed coatings still encounter significant problems. For example, seed coatings formed with FS compositions are known to have poor water resistance, which results in the loss of the active ingredient when immersing the coated seed in water. In addition, the film forming agent usually has poor adhesion strength, which results in a high expulsion rate of the coating (i.e., loss of the coating). Finally, coatings formed with FS compositions can adversely affect seed germination, which results in a waste of resources. As a result, there is a need in the art for an FS composition that provides water resistance to prevent the loss of the active ingredient, that resists expulsion from the seed surface all while not adversely affecting the germination of the coated seed.

### SUMMARY

The present disclosure provides for a flowable concentrate (FS) composition that can form a coating on an agricultural seed. The FS composition of the present disclosure uses an acrylic polymer as a film forming agent, where the acrylic polymer has a glass transition temperature (Tg) of 0 to 35° C. measured according to ASTM D6604-00 (2017). Having an acrylic polymer with the recited Tg is believed to enhance the adhesion strength of a coating formed with the FS composition while reducing its expulsion rate. Coatings formed with the FS concentrate composition of the present disclosure also does not adversely affect the germination rate of corn seeds relative to a control, which coupled with an improved water resistance and reduced expulsion rate indicates the coatings formed with the FS concentrate composition of the present disclosure may help to fill the need in the art for an FS composition that provides water resistance to prevent the loss of the active ingredient, that resists expulsion from the seed surface all while not adversely affecting the germination of the coated seed.

The FS composition for forming the coating on an agricultural seed includes a) up to 8.5 weight percent (wt. %) of an acrylic polymer having a glass transition temperature (Tg) of 0 to 35° C. measured according to ASTM D6604-00 (2017); b) 5 to 50 wt. % of an agriculturally active compound; c) 1 to 15 wt. % of a water-soluble surfactant; and d) water, where the amount of water brings the wt. % of the FS composition to 100 wt. % and where the wt. % values are based on the total weight of the FS composition. Preferably, the FS composition includes 0.225 to 5.5 wt. % of the acrylic polymer. In addition, the acrylic polymer is such that a film formed with the acrylic polymer has a water absorption rate for a 24-hour period at 23° C. of 2 to 30 weight percent based on the total weight of the film. Preferably, the acrylic polymer is such that a film formed with the acrylic polymer has a water absorption rate for a 24-hour period at 23° C. of 2 to 15 weight percent based on the total weight of the film.

For the various embodiments, the acrylic polymer is formed from monomers selected from the group consisting of, but not limited to, one or more of butyl acrylate, methyl methacrylate, methyl acrylic acid, acrylic acid, ethyl acrylate, 2-ethylhexyl acrylate, t-amyl methacrylate, n-decyl methacrylate, n-dodecyl acrylate, n-hexyl acrylate, n-octyl methacrylate, acrylonitrile and combinations thereof. In an additional embodiment, the acrylic polymer is formed from butyl acrylate and at least one additional monomer selected from the group consisting of methyl methacrylate, methyl acrylic acid, acrylic acid, ethyl acrylate, 2-ethylhexyl acrylate, t-amyl methacrylate, n-decyl methacrylate, n-dodecyl acrylate, n-hexyl acrylate, n-octyl methacrylate, acrylonitrile and combinations thereof.

Embodiments of the present disclosure also provide for the acrylic polymer being formed from monomers further selected from the group consisting of styrene, acrylamide and combinations thereof. In one preferred embodiment, the acrylic polymer is formed from butyl acrylate, methyl acrylic acid and methyl methacrylate. In an additional embodiment, the acrylic polymer is formed from acrylic acid, butyl acrylate, methyl methacrylate and styrene. As noted herein, the acrylic polymer used in the FS composition has a Tg of 0 to 35° C. measured according to ASTM D6604-00 (2017). Preferably, the acrylic polymer used in the FS composition has a Tg of 10 to 30° C. measured according to ASTM D6604-00 (2017). For the various embodiments, the agriculturally active compound is selected from the group consisting of a fungicide, an insecticide, a growth regulator, a safener, a plant activator and combinations thereof. For the various embodiments, the water-soluble surfactant is selected from the group consisting of a water-soluble wetting agent, a water-soluble dispersing agent and a combination thereof. For the various embodiments, the wetting agent is selected from the group, but not limited to, consisting of at least one nonionic alcohol alkoxylate surfactant. For the various embodiments, the dispersing agent is selected from the group, but not limited to, consisting of an anionic polycarboxylate polymer, a naphthalene condensate polymer, a nonionic ethylene oxide/propylene oxide copolymer, an anionic sulfonate surfactant, an anionic sulfate surfactant, an anionic phosphate surfactant and combinations thereof. The FS composition can include 1 to 5 wt. % of the water-soluble wetting agent and 1 to 10 wt. % of the water-soluble dispersing agent, where the wt. % values are based on the total weight of the FS composition.

The present disclosure also provides a method of forming a coating on an agricultural seed using the FS composition of the present disclosure. For example, the method can include providing the FS composition of the present disclosure in a container, adding the agricultural seed to the container; coating the agricultural seed with the FS composition; and drying the agricultural seed with the FS composition to form the coating on the agricultural seed. During the method, the agricultural seed is coated with the FS composition of the present disclosure. Upon drying, the resulting product is a coating on an agricultural seed formed using the FS composition of the present disclosure.

The present disclosure also provides for a method of using the acrylic polymer having a glass transition temperature (Tg) of 0 to 35° C. measured according to ASTM D6604-00 (2017) in a flowable concentrate (FS) composition for forming a coating on an agricultural seed. In one embodiment, the FS composition is the FS composition as provided herein.

### BRIEF DESCRIPTION OF THE DRAWINGS

FIG. 1 provides a classification of expulsion rate result. Grade 1 is the best and Grade 3 is the worst. The acceptable expulsion rate is Grade 1 and Grade 2.

FIG. 2 provides a classification of water resistance result. Grade 1 is the best and Grade 5 is the worst. The acceptable water resistance is Grade 1 and Grade 2.

### DETAILED DESCRIPTION

The present disclosure provides for a flowable concentrate (FS) composition for forming a coating on an agricultural seed. The FS composition of the present disclosure uses an acrylic polymer as a film forming agent, where the acrylic polymer has a glass transition temperature (Tg) of 0 to 35° C. measured according to ASTM D6604-00 (2017). Having an acrylic polymer with the recited Tg is believed to enhance the adhesion strength of a coating formed with the FS composition while reducing its expulsion rate. Coatings formed with the FS concentrate composition of the present disclosure also does not adversely affect the germination rate of corn seeds relative to control, which coupled with an improved water resistance and reduced expulsion rate indicates the coatings formed with the FS concentrate composition of the present disclosure may help to fill the need in the art for an FS composition that provide water resistance so as to prevent the loss of the active ingredient, that resists expulsion from the seed surface all while not adversely affecting the germination of the coated seed.

As used herein, the term “coating on an agricultural seed” means an agricultural seed that has been subjected to a procedure whereby the agricultural seed is treated with one or more adhering coating layers of the FS composition of the present disclosure.

The FS composition for forming the coating on the agricultural seed includes a) an acrylic polymer having a glass transition temperature (Tg) of 0 to 35° C. measured according to ASTM D6604-00 (2017); b) an agriculturally active compound; c) a water-soluble surfactant and d) water. It is possible that FS composition can initially be provided as a concentrate, where either (i) water or (ii) water and the agriculturally active compound are not present in the composition. In the case of (i), water can be subsequently added to the concentrate to provide the FS composition of the present disclosure. In the case of (ii), both water and the agriculturally active compound as desired can be subsequently added to the concentrate to provide the FS composition of the present disclosure.

For the various embodiments, the FS composition for forming the coating on the agricultural seed includes a) up to 8.5 weight percent (wt. %) of the acrylic polymer having a Tg of 0 to 35° C. measured according to ASTM D6604-00 (2017); b) 5 to 50 wt. % of the agriculturally active compound; c) 1 to 15 wt. % of the water-soluble surfactant and d) water. The amount of water can bring the wt. % of the FS composition to 100 wt. %. The wt. % values provided herein are based on the total weight of the FS composition, unless otherwise noted.

### Acrylic Polymer

The FS composition for forming the coating on the agricultural seed includes up to 8.5 wt. % of the acrylic polymer having a Tg of 0 to 35° C. measured according to ASTM D6604-00 (2017). Preferably, the FS composition includes 0.225 to 5.5 wt. % of the acrylic polymer. Other ranges for the wt. % of the acrylic polymer in the FS composition are also possible, such as 0.25 to 8 wt. %; 0.5 to 7 wt. %; 1 to 5 wt. % and 2 to 4 wt. %, where the wt. % is based on the total weight of the FS composition. Typically, the acrylic polymer is provided as an acrylic polymer emulsion, where the acrylic polymer in the acrylic emulsion is present in a range of 45 to 55 wt. % based on the total weight of the acrylic emulsion. However, as used herein the wt. % values for the acrylic polymer are for the acrylic polymer alone where any water present with the acrylic polymer to form or provide an acrylic polymer waterborne emulsion is not taken into account in determining the wt. % values for the acrylic polymer. Any water present in the acrylic polymer waterborne emulsion, however, is considered as at least a portion of the water component of the FS composition of the present disclosure.

For the embodiments, the acrylic polymer is formed from monomers selected from the group, but not limited to, consisting of butyl acrylate, methyl methacrylate, methyl acrylic acid, acrylic acid, ethyl acrylate, 2-ethylhexyl acrylate, t-amyl methacrylate, n-decyl methacrylate, n-dodecyl acrylate, n-hexyl acrylate, n-octyl methacrylate, acrylonitrile and combinations thereof. The use of the term “meth” followed by another term such as methacrylate refers to both acrylates and methacrylates. Embodiments of the present disclosure also provide for the acrylic polymer being formed from monomers further selected from the group consisting of styrene, acrylamide and combinations thereof. Preferably, the acrylic polymer is formed with monomers selected from the group consisting of butyl acrylate, methyl acrylic acid and methyl methacrylate. In an additional embodiment, the acrylic polymer is formed from acrylic acid, butyl acrylate, methyl methacrylate and styrene.

As noted herein, the acrylic polymer used in the FS composition has a Tg of 0 to 35° C. measured according to ASTM D6604-00 (2017). Preferably, the acrylic polymer used in the FS composition has a Tg of 10 to 30° C. measured according to ASTM D6604-00 (2017). The Tg of the acrylic polymer can be calculated by using the Fox Equation (T. G. Fox, Bull. Am. Physics Soc., Volume 1, Issue No. 3, page 123 (1956)), where calculating the T_{g,mix} of a copolymer of monomers M₁ through Mᵢ is determined using the equation:

1/T_{g,mix}≈Σᵢωᵢ/T_{g,i}

wherein T_{g,mix} is the glass transition temperature calculated for the copolymer; wᵢ is the weight fraction of monomer Mᵢ in the copolymer; Tgᵢ is the glass transition temperature of the homopolymer of Mᵢ, all temperatures being in degree Kelvin. The glass transition temperature of homopolymers may be found, for example, in “Polymer Handbook”, edited by J. Brandrup and E. H. Immergut, Interscience Publishers. In calculating Tgs herein the contribution of copolymerized graftlinking monomers is excluded. The calculated Tg is calculated from the total overall composition of the acrylic polymer.

The acrylic polymer used in the FS composition can have a weight average molecular weight of 50,000 to 500,000. Techniques for measuring the weight average molecular weight include, but are not limited to, static light scattering or gel permeation chromatography (GPC) using polystyrene standards, as are known in the art.

The polymerization techniques used to prepare the acrylic polymer are well known in the art (e.g., examples disclosed in U.S. Pat. Nos. 4,325,856; 4,654,397; and 4,814,373 among others). As noted herein, the acrylic polymer can be prepared as an acrylic polymer waterborne emulsion formed using emulsion polymerization techniques. Conventional surfactants may be used such as, for example, anionic and/or nonionic emulsifiers such as, for example, alkali metal or ammonium alkyl sulfates, alkyl sulfonic acids, fatty acids, and oxyethylated alkyl phenols. The amount of surfactant used can be from 0.1% to 6% by weight, based on the weight of total monomer. Either thermal or redox initiation processes may be used. Conventional free radical initiators may be used such as, for example, hydrogen peroxide, t-butyl hydroperoxide, t-amyl hydroperoxide, ammonium and/or alkali persulfates, typically at a level of 0.01% to 3.0% by weight, based on the weight of total monomer. Redox systems using the same initiators coupled with a suitable reductant such as, for example, sodium sulfoxylate formaldehyde, sodium hydrosulfite, isoascorbic acid, hydroxylamine sulfate and sodium bisulfite may be used at similar levels, optionally in combination with metal ions such as, for example iron and copper, optionally further including complexing agents for the metal. The monomer mixture for a stage may be added neat or as an emulsion in water. The monomer mixture for a stage may be added in a single addition or more additions or continuously over the reaction period allotted for that stage using a uniform or varying composition; preferred is the addition of the polymer monomer(s) emulsion as a single addition. Additional ingredients such as, for example, free radical initiators, oxidants, reducing agents, chain transfer agents, neutralizers, surfactants, and dispersants may be added prior to, during, or subsequent to any of the stages.

The water present in the FS composition can be provided, at least partially, by the acrylic polymer, which is typically provided in a waterborne emulsion as an acrylic polymer waterborne emulsion, as discussed herein. An acrylic polymer waterborne emulsion refers to a water-based emulsion, where the acrylic polymer of the acrylic polymer waterborne emulsion is formed with the monomers as provided herein. Examples of such waterborne emulsions include those known in the art and for example some are identified as PRIMAL™ AC-6501EF, PRIMAL™ AC-261T, PRIMAL™ SF-366, PRIMAL™ DC-420 and PRIMAL™ SF-155, all available from The Dow Chemical Company.

For the various embodiments, the acrylic polymer of the present disclosure can be further characterized in that a film formed with the acrylic polymer of the present disclosure has a water absorption rate for a 24-hour period at 23° C. of 2 to 30 weight percent based on the total weight of the film. Preferably, the acrylic polymer is such that a film formed with the acrylic polymer has a water absorption rate for a 24-hour period at 23° C. of 2 to 15 weight percent based on the total weight of the film. The method of making such a film and the measurement of the water absorption rate are provided in the Examples section below, so will not be repeated here.

### Agriculturally Active Compounds

For the various embodiments, the agriculturally active compound is selected from the group consisting of a fungicide, an insecticide, a growth regulator, a safener, a plant activator and combinations thereof. The amount of the agriculturally active compound to be used in the FS composition can vary due to the strength of the active ingredient. For the present embodiments, the amount of the agriculturally active compound used in the FS composition is from 5 to 50 wt. % based on the total weight of the FS composition. Preferably, the amount of the agriculturally active compound used in the FS composition is from 10 to 30 wt. % based on the total weight of the FS composition. The amount of the agriculturally active compound in the FS composition can vary depending on the type of seed and the particular agriculturally active compound.

Examples of suitable fungicides include those selected from Captan (N-(trichloromethyl)thio-4-cyclohexane-1,2-dicarboximide); Thiram (tetramethylthioperoxydicarbonic diamide; Metalaxyl (methyl N-(2,6-dimethylphenyl)-N-(methoxyacetyl)-DL-alaninate; Fludioxonil (4-(2,2-difluoro-1,3-benzodioxol-4-yl)-1H-pyrrol-3-carbonitrile; and Oxadixyl (N-(2,6-dimethylphenyl)-2-methoxy-N-(2-oxo-3-oxazolidinyl) acetamide. One skilled in the art will be aware of other beneficial fungicides suitable for combating harmful pathogens which are not only a problem for a particular locale where the coated seed is to be grown but also suitable for the protection of seeds in storage before planting.

Examples of suitable insecticides include those selected from thiamethoxam, azoles such as, for example, triazoles, azines, pyrethroids, organophosphates, caramoyloximes, pyrroles, pyrazoles, pyridines, amidines, halogenated hydrocarbons, and carbamates and combinations and derivatives thereof. Particularly suitable classes of insecticides include insect growth regulators, organophosphates, phenylpyrazoles and pyrethroids. Additional insecticides include those known as terbufos, chlorpyrifos, fipronil, chlorethoxyfos, tefluthrin, fiproles, phenoxycarb, diofenolan, pymetrozine, carbofuran, tebupirimfos, and imidacloprid, including imidacloprid analogs, such as (substituted or unsubstituted) nitro-, oxo-, or cyano-substituted-guanidines, enamines, iminomorpholines, piperazines, iminopiperazines, oxapiperazines, oxadiazines, oxapyridines, diazocyclohexanes, diazolidines, and morpholines.

Examples of suitable growth regulator include those selected from Antiauxins, such as clofibric acid and 2,3,5-tri-iodobenzoic acid; Auxins, such as 4-CPA, 2,4-D, 2,4-DB, 2,4-DEP, Dichlorprop, fenoprop, IAA, IBA, Naphthaleneacetamide, α-naphthaleneacetic acid, 1-naphthol, naphthoxyacetic acids, MCPA-thioethyl, potassium naphthenate, sodium naphthenate and 2,4,5-T; Cytokinins, such as 2iP, Benzyladenine, 6-benzylaminopurine, kinetin and zeatin; Defoliants, such as calcium cyanamide, dimethipin, endothal, ethephon, merphos, metoxuron, pentachlorophenol, thidiazuron and tribufos; Ethylene inhibitors, such as aviglycine, 1-methylcyclopropene; Growth inhibitors, such as abscisic acid, ancymidol, butralin, carbaryl, chlorphonium, chlorpropham, dikegulac, flumetralin, fluoridamid, fosamine, gibberellic acid, glyphosine, isopyrimol, jasmonic acid, maleic hydrazide, mepiquat, piproctanyl, prohydrojasmon, propham, 2,3,5-tri-iodobenzoic acid, morphactins [chlorfluren, chlorflurenol, dichlorflurenol, flurenol], tebuconazole, metconazole; Growth retardants, such as chlormequat, daminozide, flurprimidol, mefluidide, paclobutrazol, tetcyclacis and uniconazole; Growth stimulators, such as brassinolide, forchlorfenuron, hymexazol and thiametoxam; Unclassified plant regulators, such as azoxystrobin, benzofluor, buminafos, carvone, ciobutide, clofencet, cloxyfonac, cyanamide, cyclanilide, cycloheximide, cyprosulfamide, epocholeone, ethychlozate, fenridazon, heptopargil, holosulf, inabenfide, karetazan, lead arsenate, methasulfocarb, prohexadione, pydanon, sintofen, sulfometuron, triapenthenol and trinexapac; Plant activators, such as acibenzolar, acibenzolar-S-methyl and probenazole; Salicylates, such as salicylic acid and sodium salicylate; Jasmonates such as jasmonic acid, methyl jasmonate and cis-jasmone.

Examples of suitable safeners include those selected from benzoxazine, benzhydryl derivatives, N,N-diallyl dichloroacetamide, various dihaloacyl, oxazolidinyl and thiazolidinyl compounds, ethanone, naphthalic anhydride compounds, and oxime derivatives.

Examples of suitable plant activators include those selected from harpin, Reynoutria sachalinensis, jasmonate, lipochitooligosaccharides, and isoflavones.

The above compounds are listed as examples and are not intended to be an exhaustive list of compounds that can be used in the FS composition of the present disclosure.

### Water-Soluble Surfactant

The FS composition for forming the coating on the agricultural seed includes 1 to 15 wt. % of a water-soluble surfactant. As used herein, water-soluble means the water-soluble surfactant has a solubility in water at 25° C. of greater than 2 wt. % based on the total weight of the water-soluble surfactant and water. For the various embodiments, the water-soluble surfactant is selected from the group consisting of a water-soluble wetting agent, a water-soluble dispersing agent and a combination thereof. For example, the FS composition of the present disclosure can include 1 to 5 wt. % of the water-soluble wetting agent and 1 to 10 wt. % of the water-soluble dispersing agent. Preferably, the water-soluble surfactant is non-ionic water-soluble surfactant.

Water-Soluble Wetting Agent

The FS composition for forming the coating on the agricultural seed can include 1 to 5 wt. % of the water-soluble wetting agent. Preferably, the FS composition for forming the coating on the agricultural seed includes 1 to 3 wt. % of the water-soluble wetting agent. For the various embodiments, the water-soluble wetting agent is selected from the group consisting of at least one nonionic alcohol alkoxylate surfactant. Examples of the water-soluble wetting agent include those selected from TERGITOL™ 15-S-9, and TERGITOL™ W-600, both of the wetting agent available from The Dow Chemical Company. Preferably, the water-soluble wetting agent is a non-ionic water-soluble wetting agent.

Water-Soluble Dispersing Agent

The FS composition for forming the coating on the agricultural seed can include 1 to 10 wt. % of the water-soluble dispersing agent. Preferably, the FS composition for forming the coating on the agricultural seed includes 2 to 8 wt. % of the water-soluble dispersing agent. For the various embodiments, the water-soluble dispersing agent is selected from the group consisting of an anionic polycarboxylate polymer, a naphthalene condensate polymer, a nonionic ethylene oxide/propylene oxide copolymer, an anionic sulfonate surfactant, an anionic sulfate surfactant, an anionic phosphate surfactant and combinations thereof. Examples of the water-soluble dispersing agent include those selected from nonionic ethylene oxide/propylene oxide copolymer include commercially available products under the trade name TERGITOL™ XD, Dowfax™ D-800, Dowfax™ D-850 and combinations thereof. Examples of other suitable water-soluble dispersing agents include, but not limited to, commercially available products such as Powerblox™ D-305, Powerblox™ D-205, and OROTAN™ SN. Preferably, the water-soluble dispersing agent is a non-ionic water-soluble wetting agent.

### Water

The FS composition includes water, where the amount of water can bring the wt. % of the FS composition to 100 wt. %. As noted herein, the acrylic polymer of the present disclosure can be supplied in the form of acrylic polymer waterborne emulsion, thereby providing at least a portion of the water for the FS composition.

### Method

The present disclosure also provides a method of forming a coating on an agricultural seed using the FS composition of the present disclosure. For example, the method can include providing the FS composition of the present disclosure in a container, adding the agricultural seed to the container; coating the agricultural seed with the FS composition; and drying the agricultural seed with the FS composition to form the coating on the agricultural seed. During the method, the agricultural seed is coated with the FS composition. Upon drying, the resulting product is a coating on an agricultural seed formed using the FS composition of the present disclosure.

The present disclosure also provides for a method of using the acrylic polymer having a Tg of 0 to 35° C. measured according to ASTM D6604-00 (2017) in an FS composition for forming a coating on an agricultural seed. For the various embodiments, the FS composition is the FS composition as provided herein. The use of the acrylic polymer having a Tg of 0 to 35° C. as provided herein in other FS compositions is also possible.

Conventional means of coating may be used for forming the coating on the agricultural seed using the FS composition of the present disclosure. Various coating machines such as drum coaters and fluidized bed techniques are known and available to one skilled in the art for carrying out the coating process. Other methods, such as spouted beds may also be useful. The agricultural seeds may be pre-sized prior to coating. After coating the agricultural seeds are dried and then optionally sized by transfer to a sizing machine. These machines are known in the art for example, a typical machine used when sizing seed corn in the industry.

Film-forming compositions for enveloping coated seeds are well known in the art, and a film overcoating can be optionally applied to the coated seeds of the present disclosure. The film overcoat can protect the coating formed using the FS composition and optionally allows for easy identification of the treated seeds. In general, additives are dissolved or dispersed in a liquid adhesive, usually a polymer into or with which seeds are dipped or sprayed before drying. Alternatively, a powder adhesive can be used. Various materials are suitable for overcoating including but not limited to, methyl cellulose, hydroxypropyl methylcellulose, dextrin, gums, waxes, vegetable or paraffin oils; water soluble or water disperse polysaccharides and their derivatives such as alginates, starch, and cellulose; and synthetic polymers such as polyethylene oxide, polyvinyl alcohol and polyvinylpyrrolidone and their copolymers and related polymers and mixtures of these.

Further materials may be added to the overcoat including optionally plasticizers, colorants, brighteners and surface-active agents such as, dispersants, emulsifiers and flow agents including for example, calcium stearate, talc and vermiculite. Fluidized bed and drum film coating techniques described above can be employed for film coating.

The FS composition of the present disclosure can further include a filler. The filler can help to increase the loading rate and adjust the release of the agriculturally active compound from the coating formed with the FS composition. The amount of filler used may vary, but generally the filler can be present in the FS composition in a range of 0.005 wt. % to 5 wt. %. Examples of such fillers include, but are not limited to, absorbent or inert fillers such as wood flours, clays, activated carbon, sugars, diatomaceous earth, cereal flours, fine-grain inorganic solids, calcium carbonate and the like. Clays and inorganic solids can include calcium bentonite, kaolin, china clay, talc, perlite, mica, vermiculite, silicas, quartz powder, montmorillonite and mixtures thereof. Sugars may include dextrin and maltodextrin. Cereal flours may include wheat flour, oat flour and barley flour. One skilled in the art will appreciate that this is a non-exhaustive list of materials and that other recognized filler materials may be used depending on the agricultural seed to be coated and the agriculturally active compound used in the FS composition.

The FS composition of the present disclosure can also include one or more of an anti-freeze agent, an anti-foam agent, a thickener and/or a pigment, where the pigment can be in the form of a pigment slurry. The amount of any one of these additional components used may vary, but generally can be present in the FS composition in a range of 0.005 wt. % to 5 wt. %. Examples of anti-freeze agents include, but are not limited to, propylene glycol, ethylene glycol. Examples of anti-foam agents include, but are not limited to, DOW CORNING™ AFE-0020 Antifoam Emulsion. Examples of thickeners include, but are not limited to, xanthan gum. Examples of pigments include, but are not limited to, Pigment Permanent Red, Pigment Phthalocyanine Blue.

Virtually any agricultural seed can be coated with the FS composition to form a coating on the agricultural seed. Such agricultural seeds include, but are not limited to, cereals, vegetables, ornamentals, fruit seeds, corn (sweet and field), soybean, wheat, barley, oats, rice, cotton, sunflower, alfalfa, sorghum, rapeseed, sugarbeet, Brassica, tomato, bean, carrot, tobacco and flower seeds such as pansy, impatiens, petunia and geranium. The most preferred agricultural seeds include corn and soybean.

Some embodiments of the disclosure will now be described in detail in the following Examples.

### Examples

In the Examples, various terms and designations for materials were used including, for example, the following:

Materials

Materials employed in the examples and/or comparative examples include the following.

Corn seeds, type Xinyu No. 1.

Thiamethoxam (96.3%), an insecticide available from Noposion.

TERGITOL™ W-600, a wetting agent available from The Dow Chemical Company.

DOWFAX™ D-800 and POWERBLOX™ D-305, dispersing agents available from The Dow Chemical Company.

Propylene Glycol, an anti-freeze agent available from Shanghai Chemical reagent company.

KATHON® LX 150, a biocide agent available from Rohm & Haas Electronic Materials Company.

Magnesium aluminometasilicate available from Shanghai Chemical reagent company.

DOW CORNING™ AFE-0020 Antifoam Emulsion, an anti-foam agent available from The Dow Chemical Company.

Xanthan gum (2 wt. %) available from Shanghai Chemical reagent company.

Dycoseed Red R2002-S, a color slurry available from Tianjin Dychrom.

ROVACE™ 662 V, a vinyl-acrylic copolymer emulsion available from The Dow Chemical Company.

ROVACE™ SF-191M, a vinyl-acrylic copolymer emulsion available from The Dow Chemical Company.

DirtShield™ 12, a pure acrylic emulsion available from The Dow Chemical Company.

PRIMAL™ ECONEXT 919, a pure acrylic emulsion available from The Dow Chemical Company.

RHOPLEX™ TR934HS, a self-crosslinking water-based acrylic emulsion available from The Dow Chemical Company.

MAINCOTE™ HG100, a waterborne acrylic polymer available from The Dow Chemical Company.

PRIMAL™ AC-6501EF, a pure acrylic emulsion available from The Dow Chemical Company.

PRIMAL™ AC-261T, a pure acrylic emulsion available from The Dow Chemical Company.

PRIMAL™ SF-155, a pure acrylic emulsion available from The Dow Chemical Company.

PRIMAL™ DC420, an acrylic co-polymer emulsion available from The Dow Chemical Company.

RHOPLEX™ AC-2235M Emulsion, a pure acrylic emulsion available from The Dow Chemical Company.

Market Product is an acrylic emulsion available from Jiangsu Rotam.

### FS Composition Preparation

Prepare a 30 wt. % thiamethoxam FS formulation as seen in Table 1 as follows.

(a) Add water, wetting agent and dispersing agent into a stainless-steel jar of sand miller (GERUISI®, type: SMJ-2-180), and mix until completely dissolved to form a solution.

(b) Add anti-foam agent into the solution and mix well.

(c) Add thiamethoxam to the solution by first mixing with a glass rod and then mixing with a high-speed homogenizer (IKA® T25 digital) at 4,000 rpm for 5 minutes to form a uniform slurry.

(d) Add 50 grams of grinding beadings (Φ=2 mm) into the slurry and grind the slurry for 3 hours at room temperature (23° C.).

(e) After grinding, filter the slurry through a 100 mesh strainer to remove the grinding beadings and any large thiamethoxam particles to obtain the initial formulation.

(f) Add pigment slurry, magnesium aluminometasilicate, 2 wt. % xanthan gum and anti-freeze agent to the initial formulation and mix with high speed homogenizer at 4,000 rpm for 15 minutes.

(g) Add the acrylic polymer in the amount seen in Table 1 and identified in Tables 2 and 3 and mix well. The detail of the polymers is listed in Table 2.

TABLE 1
FS Composition with 30 wt. % Thiamethoxam

| Raw material | Wt. % |
|---|---|
| Thiamethoxam | 30 |
| Wetting Agent | 1 |
| Dispersing Agent | 4 |
| Anti-Freeze Agent | 3 |
| Anti-Foam Agent | 0.3 |
| Biocide | 0.1 |
| Magnesium Aluminometasilicate | 1 |
| Xanthan Gum (2 wt. %) | 8 |
| Pigment Slurry | 5 |
| Acrylic polymer | 10 |
| Water | Make up to 100 |

TABLE 2
Acrylic polymers used in FS Compositions

| | Example (EX) | | | |
|---|---|---|---|---|
| Acrylic | Comparative | | | |
| polymer | Example (CE) | Main monomers | Type | Tg (° C.) |
| ROVACE ™ | CE A | AM/BA/VAC | Vinyl acetate- | 29 |
| 662V | | | acrylic | |
| ROVACE ™ | CE B | AA/BA/VAC/MMA | Vinyl acetate- | 3 |
| SF-191M | | | acrylic | |
| DirtShield ™ 12 | CE C | AM/BA/MMA/MAA | Pure acrylic | 39 |
| PRIMAL ™ | CE D | Butanedioic acid, | Pure acrylic | −25 |
| ECONEXT 919 | | methylene-, polymer | | |
| | | with BA/ST/AA | | |
| RHOPLEX ™ | CE E | Butanedioic acid, | Pure acrylic | −23 |
| TR934HS | | methylene-, polymer | | |
| | | with EA/BA | | |
| MAINCOTE ™ | CE F | AA/BA/MMA | Pure acrylic | 50 |
| HG100 | | | | |
| PRIMAL ™ | EX 1 | BA/MAA/MMA | Pure acrylic | 25 |
| AC-6501EF | | | | |
| PRIMAL ™ | EX 2 | BA/MAA/MMA | Pure acrylic | 24 |
| AC-261T | | | | |
| PRIMAL ™ | EX 3 | AA/BA/MMA/ST | Styrene-acrylic | 15 |
| SF-155 | | | | |
| PRIMAL ™ | CE G | AA/BA/MMA/ST | Styrene-acrylic | 40 |
| DC420 | | | | |
| RHOPLEX ™ | CE H | AA/BA/MMA | Pure acrylic | 32 |
| AC-2235M | | | | |
| Emulsion | | | | |
| Market Product | CE I | Unknown | Acrylic Emulsion | 20 |

AM—Acrylamide; VAC—vinyl acetate; AA—acrylic acid; BA—butyl acrylate; MMA—methyl methacrylate; ST—styrene; EA—ethyl acrylate; MAA—methyl acrylic acid.

### Coating Corn Seeds

Form a coating on corn seeds at room temperature (23° C.) using the FS composition of Tables 1 and 2 as follows. Place 1 gram (g) of the FS composition into a 200 milliliter (ml) plastic bottle. Add 50 g of corn seeds into the plastic bottle and seal the bottle. Shake the bottle and its content by hand for one minute at a frequency of two times per second. After one minute, open the bottle and pour the seeds onto filter paper. Allow the FS composition on the seeds to dry at room temperature to form the coating on corn seeds.

### FS Composition Performance Tests

Use the following tests to assess the Examples and Comparative Examples of the present disclosure.

24 Hour Water Absorption

To measure water absorption, pour 10 g of the acrylic polymer onto a plastic plate (diameter about 10 mm). Allow to acrylic polymer to form a polymer film at room temperature (23° C.) over 48 hours (hrs). Peel the polymer film away from the plastic plate and cut the polymer film into pieces of about 1 cm×2 cm. Weigh a piece of the polymer film (ml) and place the piece into room temperature water. After 24 hrs, remove the piece of polymer film from the water and weigh the piece of polymer film (m2) again. Calculate the 24 hr water absorption rate with below formula:

$$24 hrs Water Absorption Rate = \frac{m 2 - m 1}{m 1} * 100 \%$$

### Expulsion Rate

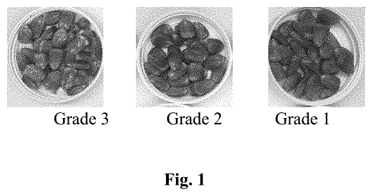

To measure expulsion rate, place 10 g of the coated corn seeds into a 250 mL conical flask and covered with a lid. Place the sealed conical flask on a IKA® rotating shaking machine, type KS501. Shake the seeds in the conical flask at a speed of 300 rotations per minute for 10 minutes. After 10 minutes, remove the seeds and visually inspect them for damage to the coating. Classify the appearance of the coated seeds based on three grades: Grade 1, Grade 2 and Grade 3, as exemplified in FIG. 1. Acceptable expulsion rates are Grade 1 and Grade 2.

### Water Resistance

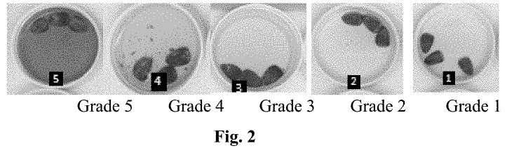

To measure water resistance, place three of the coated corn seeds in a petri dish. Cover the seeds completely with room temperature (23° C.) water and allow to sit at room temperature for 24 hrs. After 24 hrs visually inspect the water for a color change. The water resistance is classified as 5 grades as show in FIG. 2. Grade 5 is the worst and grade 1 is the best. An acceptable water resistance is Grade 1 and Grade 2.

### Germination Rate

To measure germination rate, place 20 coated seeds in a germination plate. Add enough water to the germination plate to ensure enough humidity in the environment around the seeds. Incubate the seeds at 23° C. for 7 days. After 7 days observe the number of seeds that germinated. The acceptable germination rate is same or better than the seeds which are not coated.

### Result

Table 3 provides the results of the FS composition performance tests.

TABLE 3
Results of FS Composition Performance Tests

| | | 24 hr | | | | |
|---|---|---|---|---|---|---|
| | Tg (° C.) of | Water | | | | |
| | Acrylic | Absorption | Water | Expulsion | Germination | Acceptable |
| EX/CE | Polymer | (wt %) | resistance | rate | rate (%) | Y or N |
| CE A | 29 | 41.4 | 4 | 1 | 20 | N |
| CE B | 3 | 35.1 | 3 | 3 | 80 | N |
| CE C | 39 | 10.6 | 2 | 3 | 50 | N |
| CE D | −25 | 31.4 | 1 | 3 | 85 | N |
| CE E | −23 | 17.5 | 2 | 3 | 80 | N |
| CE F | 50 | 4.0 | 2 | 3 | 60 | N |
| EX 1 | 25 | 8.0 | 1 | 1 | 85 | Y |
| EX 2 | 24 | 5.0 | 1 | 2 | 85 | Y |
| EX 3 | 15 | 14.0 | 1 | 2 | 95 | Y |
| CE G | 40 | 3.6 | 1 | 3 | 65 | N |
| CE H | 32 | 15 | 3 | 3 | 85 | N |
| CE I | 20 | 31 | 2 | 3 | 85 | N |
| No | | | 5 | 3 | 80 | N |
| polymer | | | | | | |
| (Control) | | | | | | |

As showed in Table 3, EX 1, EX 2 and EX 3 provide acceptable performance for each of water resistance, expulsion rate and seed germination rate for the coating formed with the given FS composition.

1. A flowable concentrate (FS) composition for forming a coating on an agricultural seed, comprising:
a) up to 8.5 weight percent (wt. %) of an acrylic polymer having a glass transition temperature (Tg) of 0 to 35° C. measured according to ASTM D6604-00 (2017);
b) 5 to 50 wt. % of an agriculturally active compound;
c) 1 to 15 wt. % of a water-soluble surfactant; and
d) water, where the amount of water brings the wt. % of the FS composition to 100 wt. % and where the wt. % values are based on the total weight of the FS composition.

2. The FS composition of claim 1, wherein the acrylic polymer is formed from monomers selected from the group consisting of butyl acrylate, methyl methacrylate, methyl acrylic acid, acrylic acid, ethyl acrylate, 2-ethylhexyl acrylate, t-amyl methacrylate, n-decyl methacrylate, n-dodecyl acrylate, n-hexyl acrylate, n-octyl methacrylate, acrylonitrile and combinations thereof.

3. The FS composition of claim 1, wherein the acrylic polymer is formed from butyl acrylate and at least one additional monomer selected from the group consisting of methyl methacrylate, methyl acrylic acid, acrylic acid, ethyl acrylate, 2-ethylhexyl acrylate, t-amyl methacrylate, n-decyl methacrylate, n-dodecyl acrylate, n-hexyl acrylate, n-octyl methacrylate, acrylonitrile and combinations thereof.

4. The FS composition of claim 2, wherein the acrylic polymer is formed from monomers further selected from the group consisting of styrene, acrylamide and combinations thereof.

5. The FS composition of claim 1, wherein the acrylic polymer is formed from butyl acrylate, methyl acrylic acid and methyl methacrylate.

6. The FS composition of claim 1, wherein the acrylic polymer is formed from acrylic acid, butyl acrylate, methyl methacrylate and styrene.

7. The FS composition of claim 1, wherein the acrylic polymer has a Tg of 10 to 30° C. measured according to ASTM D6604-00 (2017).

8. The FS composition of claim 1, wherein the FS composition includes 0.225 to 5.5 wt. % of the acrylic polymer.

9. The FS composition of claim 1, wherein the agriculturally active compound is selected from the group consisting of a fungicide, an insecticide, a growth regulator, a safener, a plant activator and combinations thereof.

10. The FS composition of claim 1, wherein the water-soluble surfactant is selected from the group consisting of a water-soluble wetting agent, a water-soluble dispersing agent and a combination thereof.

11. The FS composition of claim 10, wherein the water-soluble wetting agent is selected from the group consisting of at least one nonionic alcohol alkoxylate surfactant.

12. The FS composition of claim 10, wherein the water-soluble dispersing agent is selected from the group consisting of an anionic polycarboxylate polymer, a naphthalene condensate polymer, a nonionic ethylene oxide/propylene oxide copolymer, an anionic sulfonate surfactant, an anionic sulfate surfactant, an anionic phosphate surfactant and combinations thereof.

13. The FS composition of claim 10, wherein the FS composition includes:
1 to 5 wt. % of the water-soluble wetting agent; and
1 to 10 wt. % of the water-soluble dispersing agent.

14. The FS composition of claim 1, wherein a film formed with the acrylic polymer has a water absorption rate for a 24-hour period at 23° C. of 2 to 30 weight percent based on the total weight of the film.

15. The FS composition of claim 1, wherein a film formed with the acrylic polymer has a water absorption rate for a 24-hour period at 23° C. of 2 to 15 weight percent based on the total weight of the film.

16. An agricultural seed coated with the FS composition of claim 1.

17. A coating on an agricultural seed formed using the FS composition of claim 1.

18. A method of forming a coating on an agricultural seed, comprising:
providing the FS composition of claim 1 in a container;
adding the agricultural seed to the container;
coating the agricultural seed with the FS composition; and
drying the agricultural seed with the FS composition to form the coating on the agricultural seed.

19. A method of using an acrylic polymer having a glass transition temperature (Tg) of 0 to 35° C. measured according to ASTM D6604-00 (2017) in a flowable concentrate (FS) composition for forming a coating on an agricultural seed.

20. The method of claim 19, wherein the FS composition is the FS composition of claim 1.
